(19) United States
(12) Patent Application Publication
(10) Pub. No.: US 2016/0148469 A1
(43) Pub. Date: May 26, 2016

(54) MULTI-JURISDICTIONAL PROGRESSIVE FAST PLAY LOTTERY GAMES AND ASSOCIATED METHODS

(71) Applicant: Intralot, Inc., Duluth, GA (US)

(72) Inventors: Scott R. Hoss, Cumming, GA (US); John Pittman, Duluth, GA (US)

(73) Assignee: Intralot, Inc., Duluth, GA (US)

(21) Appl. No.: 14/966,062

(22) Filed: Dec. 11, 2015

Related U.S. Application Data
(63) Continuation of application No. PCT/US2014/061488, filed on Oct. 21, 2014.
(60) Provisional application No. 61/893,483, filed on Oct. 21, 2013.

(51) Int. Cl. G07F 17/32

(52) U.S. Cl. CPC G07F 17/3258; G07F 17/329

(57) ABSTRACT

A method of conducting a multi-jurisdictional lottery game includes maintaining a jackpot for the multi-jurisdictional lottery game and establishing a minimum amount of the jackpot. Lottery players in each of the participating lottery jurisdictions purchase tickets and a portion of the ticket price is contributed to the multi jurisdictional lottery game jackpot. An updated jackpot amount is communicated to each of the jurisdictions. A notification is issued from one of the jurisdictions that a potential winning jackpot player has won the multi-jurisdictional lottery game. The multi jurisdictional lottery game, in the form of a master controller then verifies that the potential winning jackpot player has won the multi-jurisdictional lottery game. Each of the jurisdictions is then notified that the multi-jurisdictional lottery game has been won if the verification indicates as such. Once the jackpot is won, it is then re-established at the minimum amount and a new game commences.

### CROSS REFERENCE TO RELATED APPLICATION

This application claims the benefit of PCT Application No. PCT/US2014/061488, filed on Oct. 21, 2014 which claims the benefit of U.S. Provisional Patent Application Ser. No. 61/893,483, filed on Oct. 21, 2013, and herein incorporated by reference in their entirety.

### BACKGROUND OF THE INVENTION

This invention relates to lotteries and, more particularly, to a multi-jurisdictional progressive fast play lottery game and associated methods of conducting such lottery games.

Lotteries have existed in various forms throughout the world for hundreds of years. Typical modern lottery formats often involve the selection by a customer or entrant of a pre-determined quantity of lottery numbers (e.g., from a range of numbers) such as by writing such numbers down on a paper form which is submitted to a store clerk. Once the lottery ticket is paid for, such numbers are then entered into a machine which prints, on a second piece of paper, a lottery ticket which is issued to the lottery customer. Lottery winners in such conventional lotteries are eventually chosen by a lottery administrator which—via one or more conventional methods—draws or randomly selects winning numbers which an entrant must have selected, and thereby have a paper ticket with numbers matching the winning numbers, to win the lottery prize. If the paper lottery ticket is lost, the contestant—even if he or she were a winner—would be unable to collect his/her prize. Because the contestant is able to choose whatever numbers he or she desires in such lotteries, multiple winners are possible which necessitates prize sharing. Conversely, because there is no guarantee that the numbers drawn will precisely match any set of numbers chosen by a lottery contestant, a given lottery draw may result in no winner at all.

In a popular second type of lottery format, paper tickets are sold to lottery customers which are a scratch-off type or a variety of so-called instant win tickets. With such a lottery ticket, often the ticket is predetermined as either a winner or a loser and the customer discovers the “result” of the ticket by scratching or rubbing off an opaque film which conceals whether the ticket is a winning or losing ticket. Because of the simplicity of their design and implementation, there are often a large variety of scratch-off lottery ticket types which compete with one another.

As most conventional lottery types employ paper tickets, not only does the printing of massive numbers of throw away tickets have an environmental impact, but it also requires substantial financial expenditure by the lottery provider to design, print, store, and ship the tickets to large numbers of geographically distant locations.

The popularity of lotteries in recent years has declined despite the social benefits such as providing entertainment and sources for civic funding of schools and other institutions. The decline is possibly due to a lack of excitement or enthusiasm associated with conventional lotteries. In this regard, the public has arguably become sensitized to the conventional lottery formats and therefore does not participate in such lotteries as frequently.

Therefore, needs exist in the lottery industry including, for example, a need for new lottery game types which elicit greater participation by lottery contestants. As other examples, there is a need for lottery (or game) types with reduced environmental impact and/or which are less expensive and cumbersome to administer. However, barriers exist for new types of lottery games. State lotteries are offered on a large scale, and are operated using centralized transaction processing systems to collect and/or redeem wagers. Most state lotteries and similar entities operate their own central host system, or have it operated by a contractor. The host systems are typically located within the jurisdiction of the lottery provider. The state lotteries also deploy their own client equipment to operate various channels for delivering games to player customers, such as agent-operated lottery game sales terminals, unattended lottery game sales terminals, vending machines, kiosks, electronic access via the Internet from personal computers, mobile phone access, and interactive TV terminal access, etc. They also operate, or have operated on their behalf by a contractor, their own customized administration systems, such as accounting, reporting, fraud control, prize redemption systems, etc.

Deploying new games on state lottery systems or in other gaming operations typically requires significant custom programming and the rollout of new features in all the various customized administration systems. This can take large amounts of time and resources. When a lottery has a successful new game, other lotteries want to emulate the game, which then requires additional custom work.

Generally, when the same game is offered in multiple jurisdictions, each jurisdiction has its own implementation (often with variations to the business rules or play style). Even for multi jurisdictional games like Powerball®, each participating jurisdiction has its own instance of the game and the process of determining winners for the shared jackpot is done separately in each jurisdiction—often with “low tech” exchange of data like fax or email for winning numbers, share values, etc.

In view of the above-enumerated drawbacks and/or needs or desires for improvements in the lottery industry, one purpose of the herein described invention is to address one or more of such drawbacks and/or desires as well as, or in the alternative, other needs which will become more apparent to the skilled artisan based on this disclosure.

### SUMMARY OF THE INVENTION

In various embodiments, this invention is directed to a method of conducting a multi jurisdictional lottery game in which a jackpot for the multi-jurisdictional lottery game is maintained. A minimum jackpot amount for the multi-jurisdictional game is established. The method also includes coordination with a number of jurisdictions regarding a number of individual jurisdictional lottery games each being conducted within one of the jurisdictions in which lottery players each participate in one of the individual jurisdictional lottery by purchasing a lottery chance at a lottery game price. A portion of the lottery game price for each lottery chance purchased by each of the plurality of lottery players is contributed to the multi-jurisdictional lottery game jackpot. Periodically and typically on a regularly scheduled interval, an updated jackpot amount is communicated to each of the.

A notification may be issued from at least one of the jurisdictions that a potential winning jackpot player has won the multi-jurisdictional lottery game. The multi jurisdictional lottery game, in the form of a master controller in one embodiment, then verifies that the potential winning jackpot player has won the multi jurisdictional lottery game. Each of the jurisdictions is then notified that the multi-jurisdictional lottery game has been won if the verification indicates as such. Once the jackpot is won, it is then re-established at the minimum jackpot amount and a new game may commence.

If more than one notification is received that the jackpot has been won, the master controller may determine which of the players claiming the jackpot is entitled to it, and in one embodiment of this invention the first potential winning player to claim the jackpot is awarded the jackpot.

In other embodiments, this invention may be directed toward a method of playing a lottery game, a lottery game implemented by one or more game terminals in communication with a server via a communication network, a system for hosting a lottery game across multiple jurisdictions, a program product embodied in one or more tangible computer readable media with a code executable by a gaming machine and a gaming server, a tangible non-transitory computer readable medium storing a program product which includes computer executable program code, a method for implementing a network-based lottery game and a gaming apparatus or system for a multi-jurisdictional lottery game.

### BRIEF DESCRIPTION OF THE DRAWINGS

The above-mentioned and other features and advantages of this invention, and the manner of attaining them, will become more apparent and the invention itself will be better understood by reference to the following description of embodiments of the invention taken in conjunction with the accompanying drawings, wherein:

FIG. 1 is a schematic representation of how a player may engage a state or local jurisdiction lottery system according to one aspect of this invention;

FIG. 2 is a schematic representation of the organization of a multi-jurisdictional lottery game network of one embodiment of this invention;

FIG. 3 is a schematic flow chart of the operation of a multi jurisdictional lottery game of one embodiment of this invention;

FIG. 4 is a view of an exemplary lottery ticket which may be used in one embodiment of a lottery game according to this invention;

FIG. 5 is a flow chart of one embodiment of lottery game processing according to this invention; and

FIG. 6 is a flow chart of one embodiment of a lottery game drawing process and jackpot (JP) management according to this invention.

### DETAILED DESCRIPTION OF THE INVENTION

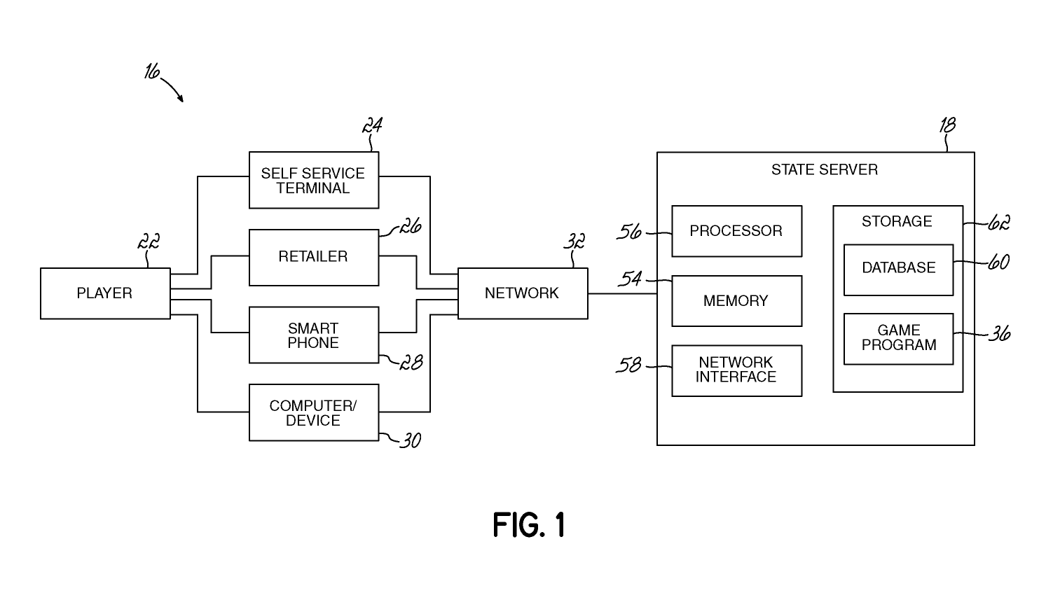

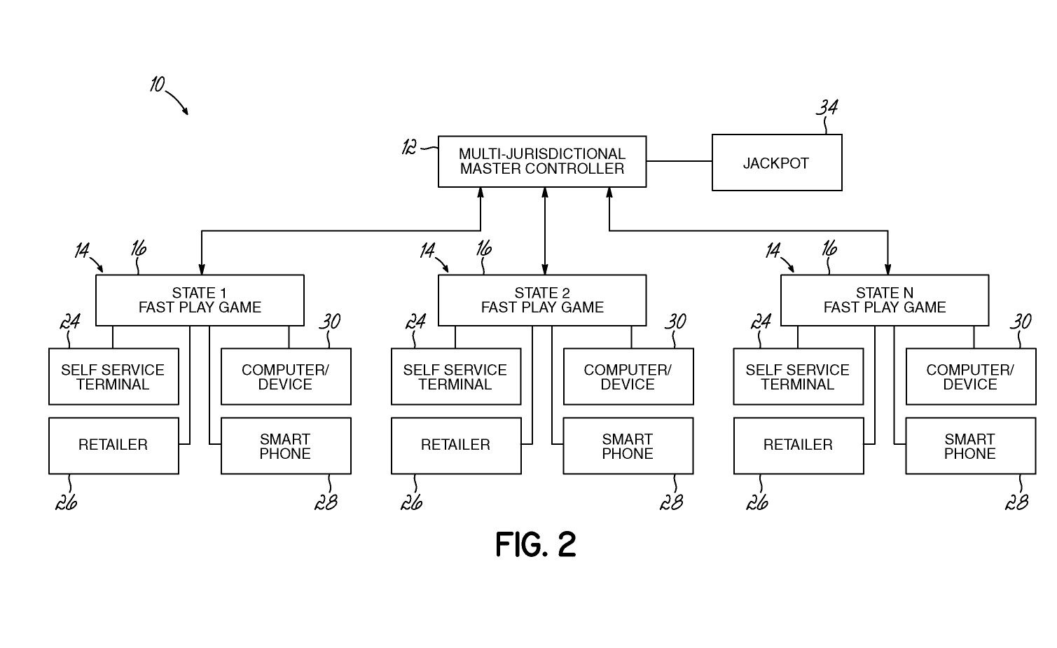

Referring to the drawings, and in particular FIGS. 1-3, a multi-jurisdictional lottery game 10 according to various embodiments of this invention is operated by a multi jurisdictional master controller 12. The master controller 12 is utilized to operate the multi-jurisdictional lottery game 10 across a number of distinct lottery jurisdictions 14, such as state lottery authorities in the US. As shown in FIGS. 1-3, the multi-jurisdictional game 10 may be played in multiple and distinct lottery jurisdictions 14 and this is represented in FIG. 2 by State 1, State 2 and up to any number of jurisdictions 14 as shown by State N. Each distinct jurisdiction 14 may employ a similar lottery game 16 or the various jurisdictions 14 may employ varied and different lottery games 16 from each of the other jurisdictional games. In various embodiments, the jurisdictional lottery games 16 are each fast play progressive games, examples of which are commonly known to those of ordinary skill in this art.

Each jurisdictional lottery game 16 may be conducted by a state lottery authority which may utilize a jurisdictional or state lottery server 18 to operate the jurisdictional game 16. One example of the organization and operation of a state or jurisdictional lottery game 16 is shown in FIG. 1. The arrangement shown in FIG. 1 may be utilized by any or all of the individual jurisdictions 14 State 1, State 2 through State N for operation of the respective jurisdictional lottery games 16. Alternatively, one or more jurisdictions 14 may use a different game architecture for operation of the associated jurisdictional game 16 according to various embodiments of this invention. Examples of the differences among the various jurisdictional lottery games that may be utilized within this invention include differing game themes, names, odds, payouts at the state level, prices, methods of conducting the game including, but not limited to, the generation of the random numbers for participation and/or winning at the state level or any other variable which may be utilized as known by those of skill in this art. While the jurisdictional games may be varied, each must include a common component for participation in the multi-jurisdictional game according to this invention.

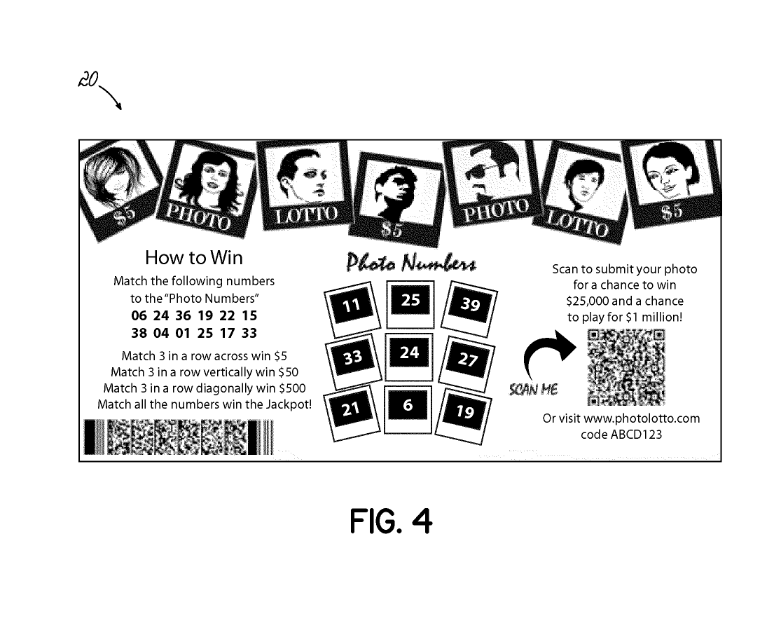

Each jurisdictional lottery game 16 (FIG. 1) may include the sale of a lottery ticket 20, an example of which is shown in FIG. 4. The lottery ticket 20 is sold to a lottery player 22 by the respective state, jurisdiction, or lottery authority 14 for participation in the associated jurisdictional lottery game 16. The player 22 may utilize a self-service terminal 24, a lottery retailer 26, their own smart phone 28, a computer or other device 30 to purchase the ticket 20. Each of these devices 24, 26, 18, 3o is in communication with the state server 18 via a network 32 such as the internet or a dedicated communication network. Each lottery ticket 20 may entitle the lottery player 22 participation in the local jurisdictional lottery game 16 and participation in the multi-jurisdictional lottery game 10 according aspects of this invention. The lottery ticket 20 may be issued in paper, electronic or another form as is well known. The local lottery authority charges a ticket price for the purchase of the lottery ticket and participation in the jurisdictional 16 and/or multi jurisdictional game 10. A portion of the ticket price is transmitted to the multi jurisdictional lottery authority 12 for adding to the multi-jurisdictional jackpot 34. In one embodiment of this invention, while the individual jurisdictional games 16 conducted by the local lottery authorities State 1, State 2 through State N 14 may be varied, the contribution amount to the multi jurisdictional jackpot for each purchased ticket 20 is the same across the various jurisdictions State 1, State 2 through State N 14 participating in the multi jurisdictional game 10.

The master controller 12 maintains a running total of the multi-jurisdictional jackpot 34 and, according to one embodiment of this invention, updates each local jurisdiction State 1, State 2 through State N 14 on a regular and predetermined schedule the amount of the jackpot 34. For example, the master controller 12 may update the local jurisdictions 14 every two minutes with the current jackpot 34 amount. The local lottery authorities or jurisdictions 14 then may transmit the latest multi-jurisdictional jackpot 34 information to the lottery players 22 and/or prospective players.

The multi jurisdictional lottery game 10 may be won by any participating player 22 in any of the participating jurisdictions State 1, State 2 through State N 14. However, each jackpot 34 of the multi-jurisdictional game 10 may be won by only one participating player 22 and the determination is made by the master controller 12 should more than one player 22 claim the jackpot 34. In one embodiment, the master controller 12 fields inquiries and claims from each jurisdiction 14 in which a player 22 claims to have won the jackpot 34. The master controller 12 then verifies the winner and determines which of the possible claimants was the first in time to claim the jackpot 34 with a winning lottery ticket. In the highly unlikely event that two potential winners submit their claim to the master controller 12 at exactly the same instance, then the master controller 12 will award the jackpot to one of the claimants, divide the jackpot among the claimants and/or another course of action as prescribed by the rules of the multi jurisdictional game 10. After the jackpot 34 is awarded to the winning player, then the master controller re-sets the jackpot 34 to the minimum amount and another multi jurisdictional game 10 begins anew as previously described.

According to various aspects of this invention, each state or jurisdiction 14 has its own core fast play (FP) game engine or program 36 like any other traditional FP game. Typically, fast play games 16 are instant-style games that are played through a lottery terminal 24 or other device. Instead of filling out a bet-slip, a player 22 obtains a ticket 20 from a lottery retailer 26 for a fast play game. Alternatively, fast play game tickets 20 can be purchased by the player 22 through the lottery terminal 24 or other device 28, 30. One aspect of a fast play game is that a play slip does not need to be filled out and the player 22 does not need to select numbers to be played. Also, the player 22 does not need to wait for a drawing to determine if they are a winner. In certain aspects, fast play games are similar to the well known scratch-off ticket games, but no scratching is required in many fast play games. The numbers or symbols on the fast play ticket are compared to the winning numbers/symbols to determine a winner. The player's numbers and the winning numbers are often determined via a random number generator (RNG) or other method. A lottery agent or retailer may scan or otherwise check a player's ticket 20 to determine if it is a winning ticket. The variables of each FP game according to various embodiments of this invention can be different from state to state or jurisdiction to jurisdiction. Such variables may include different bitmaps or game designations or logos, random number generator (RNG) or pool based generation of the numbers/symbols, and different tiers and dividends from game to game, state to state or jurisdiction to jurisdiction.

In one embodiment of this invention, the FP game may have different tiers and the odds of winning a first tier are the same, but other tiers can have different odds, and the price point may be the same so that the percentage of the ticket price or cost for playing to be contributed to the jackpot 34 will be the same per play according to one aspect of this invention.

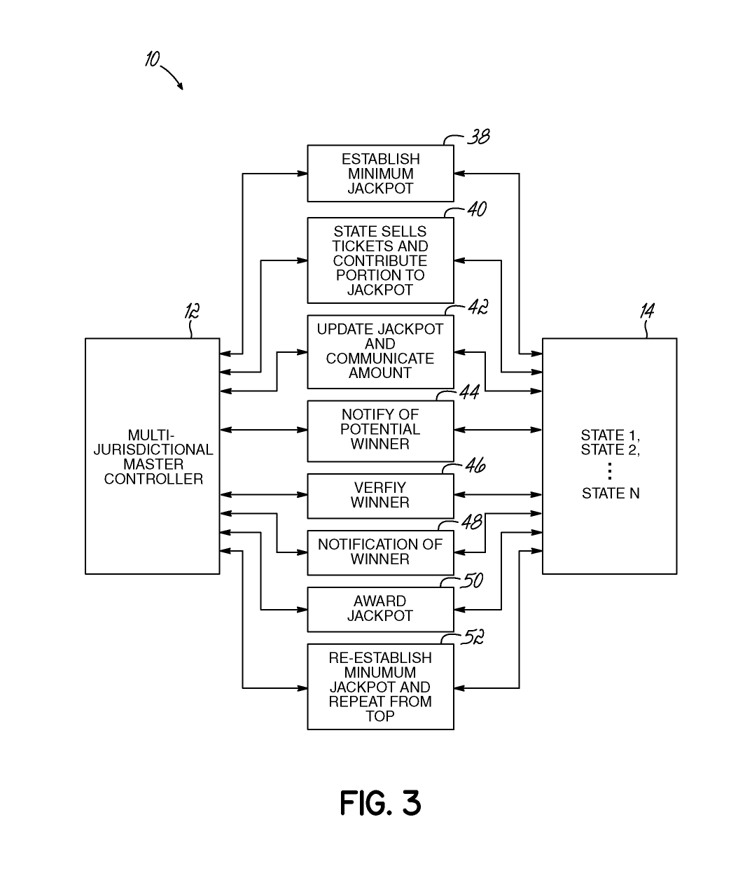

Referring to FIG. 3, the game 10 according to one aspect of this invention includes a master multi jurisdictional controller 12 which may be provided that will support the calculation of the jackpot 34, the notification of the current jackpot on a pre-defined, regular interval, for example every two minutes or more, and the election of the jackpot winner or winners in case of multiple concurrent winners across different states or jurisdictions 14. The game 10 starts with a minimum jackpot established 38.

Upon every lottery play transaction 40 according to aspects of this invention, the local jurisdiction or state system 14 will make an application programming interface (API) call that will notify the master controller 12 of the dollar amount (based on cents) of the ticket value played. The master multi jurisdictional controller 12 will update the current jackpot 34 upon every such transaction.

At each interval, (i.e., every 2 minutes or more), the master controller 12 will update and propagate 42 back to all of the individual states or jurisdictions 14 that participate in the game 10 the currently active current jackpot 34 amount. It is then the responsibility of each state authority 14 to propagate that information to their respective points of sale (POS) and associated lottery players 22.

The election of the jackpot winner across the multi jurisdictional play is another aspect of this invention. At any point of time that the local state lottery 14 based on the RNG or from the pool file, have a jackpot winner (potential) instead of replying instantly back to the terminal 24 or other device, it will send that information 44 to the master system controller 12. According to aspects of this invention, the implementation across multiple states or jurisdictions 14 can result in more than one potential jackpot winner at the same second, so the master controller 12 will nominate which specific state ticket/player among the potential winners is actually the winner (based on a first in, first out (FIFO) algorithm). So the first ticket will be the winner and will get the jackpot amount according to one aspect of this invention. The master controller 12 will verify the winner 46 and propagate to all local lottery authorities 14 the identity of the winner 48, and the jackpot will then be awarded to the winner 50 and revert back 52 to the minimum jackpot amount. The notification of the winner 48 will be instantaneous and not dependent upon a chosen time interval in this case.

Suitable examples of gaming devices of this invention which may be specialized and adapted for this invention include video lottery terminals, virtual lottery draw machines, slot machines, video poker machines, digital roulette machines, hand-held cell phones or other personal digital assistants, web sites, POS TV monitors, touch-screens and others. Conceptual principles of a system for implementing a network-based lottery game wherein players are given access to a network game site for play of a lottery game having a predetermined outcome according to various embodiments of this invention include the following. It should be understood that this invention, system and associated methods are not limited by any particular type of game, and the term “lottery game” is used herein to denote any type of probability-based game offered to eligible persons. The games may be presented to players purely for entertainment value at no cost to the player. Prizes may be awarded to a player for a winning game play, which may include a cash award. In other embodiments, the player places a wager amount for play of the lottery game in the hopes of winning a cash award or other type of prize.

The game may be administered by a lottery provider, which is the entity that provides a lottery to a gaming authority or administrator. In an alternate embodiment, the lottery provider and gaming authority may be the same entity. The gaming authority may be, for example, a state or other regional governmental entity that provides lottery games to eligible players via authorized retailers or retail establishments. In the United States, for example, the gaming authority may be a state or affiliation of states that offers lottery games to their residents via the sale of lottery games at authorized retail establishments.

The gaming authority typically utilizes a central host computer system in communication with the various retail establishments, particularly the lottery terminals maintained at the retail establishments (also referred to as point-of-sale terminals) one example of which is shown in FIG. 1. Typically, a vast number of such terminals are operatively coupled to the central host computer system via any suitable communications network 32, which may be, for example, the Internet, a wide area network (WAN), a local area network (LAN), a telephone system, and so forth. In a particular embodiment, the lottery network may include a state lottery system operating within an individual state or region of states, wherein the lottery terminals 24 are interconnected to the game administrator and host computer server 18 directly or through an intermediary network for tracking, administration, and coordination of the state lottery system, including control of issued tickets, prizes, amounts wagered, and so forth. It should be readily appreciated that this invention encompasses any suitable communications network architecture that provides the lottery player with the ability to communicate and interact with the game administrator's central host computer system 18.

The point-of-sale terminals 24 or other gaming device 26, 28, 30 may include any conventional feature known to those skilled in the art related to lottery terminals. The terminal includes features and functionality to allow a player or retail clerk to enter the information required to participate in the lottery game 10, 16. An exemplary terminal includes a housing, one or more input devices, which may be a control panel having input keys, a display, a value input device such as a card reader, a play slip or ticket reader, and a ticket printer. The play slip reader is typically configured to read user selection marks, bar codes, magnetically stored information, or any other desired input information and may be omitted in various embodiments. Control panel input keys allow the player or retail clerk to select the game to be played, input the value to be wagered, manually enter selected lottery characters (if needed), and input any other information necessary to play the lottery game. The terminal may include a display which may be an LCD, a CRT, or touch-screen capable of receiving and displaying information related to the game. The value input device may include any device that can accept value or a wager from a customer, such as a card reader or an optical currency collector. The value input device may be integrated with external devices, such as a cash register or other retail terminals, to exchange information necessary to receive and record the wagering transaction. The player may also draw from a player's account with the lottery 14. The lottery ticket printer may be used to print or otherwise encode lottery tickets with information selected or required to play the lottery game. The printer may provide lottery tickets that reflect a player's selections, or complete lottery slips if the selection was generated automatically by the terminal.

The host computer system 12, 18 may be a single networked computer or a series of interconnected computers having access to the lottery system or network via any suitable networking system. Generally, such computer systems are configured to manage, execute, and control the individual lottery terminals and the routines used to play various lottery games, or track information related to the sale and distribution of pre-printed instant lottery tickets, such as scratch-off lottery tickets. The host computer may include memory 54 for storing lottery programs, files, and routines, a microprocessor 56 for executing stored routines, random access memory (RAM), and an input/output (I/O) bus 58. In addition, the host computer may be in communication with any manner of external device, including external databases. Such databases 60 may provide a data repository for the storage 62 and correlation of information gathered from the individual lottery terminals relating to the individual terminals, such as terminal specific information like the machine ID, sales establishment, location, and ticket-specific information. It should be readily appreciated that the host computer 12, 18 may encompass any configuration of hardware and software applications necessary to manage, execute, and control administration of the lottery game 10, 16.

A game server system may be provided with any suitable hardware and software configuration for enabling play of network-based lottery games whereby players access a game site (e.g., an Internet site) maintained by the game server system via a network-enabled device and communications network. The network-enabled device may be, for example, a personal computer, smart phone, personal digital assistant (PDA), or other intelligent communications device. The communication network may be, for example, the Internet, a wide area network (WAN), a local area network (LAN), a telephone system, and so forth. In a particular embodiment, the game server system maintains an Internet game site accessible to players via the Internet.

It should be appreciated that this game system and method are not limited to an Internet implementation, but encompass any system configuration wherein players are provided access to a game site via a communications network. This network may be a WAN or LAN provided, for example, solely to patrons of certain establishment, such as a casino or other type of gaming house.

A lottery ticket 20 may be used to initiate the game. One embodiment of a ticket includes any manner of indicia that advertises, describes, illustrates, or in any way presents aspects of the particular lottery game to a player 22. The lottery ticket 20 may include a game component that is completely independent of the network-based game. For example, the lottery ticket may implement an instant-win game wherein players play a scratch-off game in the game area. As is well known, typical scratch-off games include game indicia and prize award indicia that are covered by a removable coating. The player removes the coating to reveal whether or not the ticket represents a win or loss. It should be appreciated that this invention is not limited by any particular type of additional game component implemented by the ticket, and that the scratch-off game described is for representative purposes only.

A game playing and viewing system according to one embodiment of this invention may include a number of components for performing specific functions. The components may include, for example, storage components for data structures for storing game variations, present game session information, game session history, and win history. A game playing and viewing system may also include components used to access the payment and payout data structures.

The game playing and viewing system according to one embodiment of this invention may also include a game engine or program 36. A game engine may perform numerous functions, including drawing winning elements for a game and displaying the drawn winning elements through any communication means, including on a lottery terminal, over the Internet (e.g., through a website or internet messaging, or e-mail), or by text messaging on a cell phone. The game playing and viewing system may also receive communication from players indicating a winning game ticket. Communication may be received using any method, including over the Internet (e.g., through a website, Internet messaging, or e-mail) or by text messaging on a cell phone.

Acts described above and various embodiments and variations of these methods and acts, individually or in combination, may be defined by computer-readable signals tangibly embodied on a computer-readable medium, for example, a non-volatile recording medium, an integrated circuit memory element, or a combination thereof. Such signals may define instructions, for example, as part of one or more programs that, as a result of being executed by a computer, instruct the computer to perform one or more of the methods or acts described herein, and/or various embodiments, variations and combinations thereof. Such instructions may be written in any of a number of programming languages, for example, Java, Visual Basic, C, C#, or C++, Fortran, Pascal, Eiffel, Basic, COBOL, etc., or any of a variety of combinations thereof. The computer-readable medium on which such instructions are stored may reside on one or more of the components of a general-purpose computer described above, and may be distributed across one or more of such components.

The computer-readable medium may be transportable such that the instructions stored thereon can be loaded onto any computer system resource to implement the aspects of this invention discussed herein. In addition, it should be appreciated that the instructions stored on the computer-readable medium, described above, are not limited to instructions embodied as part of an application program running on a host computer. Rather, the instructions may be embodied as any type of computer code (e.g., software or microcode) that can be employed to program a processor to implement the above-discussed aspects of this invention.

It should be appreciated that any single component or collection of multiple components of a computer system, e.g., the computer system described below, that performs the functions described above can be generically considered as one or more controllers that control the above-discussed functions. The one or more controllers can be implemented in numerous ways, such as with dedicated and specialized hardware, or using a processor that is programmed using microcode or software to perform the functions recited above.

Another component of the game playing and viewing system may be a driver that streams video via a broadband, satellite, or wireless medium to a user interface. If the game is played completely automatically, the user interface may be merely a video terminal including television with no user input means. Viewing access may be controlled by standard means for conditional access including using set top box addresses, telephone numbers or Internet protocol (IP) addresses.

The above is merely an illustrative embodiment of a game playing and viewing system. Such an illustrative embodiment is not intended to limit the scope of the invention, as any of numerous other implementations of a game playing and viewing system; for example, variations of conditional access are possible and are intended to fall within the scope of the invention. This invention is not intended to be limited to any particular implementation of a game playing and viewing system unless such claim includes a limitation explicitly reciting a particular implementation.

This invention and components thereof such as the payment, payout, and game engines, may be implemented using software (e.g., C, C#, C++, Java, or a combination thereof), hardware (e.g., one or more application-specific integrated circuits, processors or other hardware), firmware (e.g., electrically-programmed memory), or any combination thereof. One or more of the components may reside on a single system (e.g., the payment subsystem), or one or more components may reside on separate, discrete systems. Further, each component may be distributed across multiple systems, and one or more of the systems may be interconnected.

Further, on each of the one or more systems that include one or more components, each of the components may reside in one or more locations on the system. For example, different portions of the components may reside in different areas of memory (e.g., RAM, ROM, disk, etc.) on the system. Each of such one or more systems may include, among other components, a plurality of known components such as one or more processors, a memory system, a disk storage system, one or more network interfaces, and one or more busses or other internal communication links interconnecting the various components.

This invention may be implemented on a computer system described below. Computer system is merely an illustrative embodiment of a game system. Such an illustrative embodiment is not intended to limit the scope of the invention, as any of numerous other implementations of the game system, for example, variations of the system, are possible and are intended to fall within the scope of the invention. For example, a parallel system for viewing by interactive television may include one or more additional video streamers specific for interactive television. None of the claims set forth below are intended to be limited to any particular implementation of the game system unless such claim includes a limitation explicitly reciting a particular implementation.

Various embodiments according to the invention may be implemented on one or more computer systems. These computer systems may be, for example, general-purpose computers such as those based on Intel PENTIUM-type processor, Motorola PowerPC, Sun UltraSPARC, Hewlett-Packard PA-RISC processors, or any other type of processor. Moreover, cloud based hosting may be utilized with this invention. It should be appreciated that one or more of any type computer system may be used to partially or fully automate play of the described game according to various embodiments of the invention. Further, the software design system may be located on a single computer or may be distributed among a plurality of computers attached by a communications network.

A computer system according to one embodiment of the invention may be specially configured to perform any of the described game functions including, but not limited to, player subscription or payment, player chosen elements or elements chosen for the player, drawing winning elements, and communicating with, verifying, and paying winners. It should be appreciated that the system may perform other functions, including network communication, and the invention is not limited to having any particular function or set of functions.

For example, various aspects of the invention may be implemented as specialized software executing in a specially adapted computer system. The computer system may include a processor connected to one or more memory devices, such as a disk drive, memory, or other device for storing data. Memory is typically used for storing programs and data during operation of the computer system. Components of computer system may be coupled by an interconnection mechanism, which may include one or more busses (e.g., between components that are integrated within a same machine) and/or a network (e.g., between components that reside on separate discrete machines). The interconnection mechanism enables communications (e.g., data, instructions) to be exchanged between system components of system. Computer system also includes one or more input devices, for example, a keyboard, mouse, trackball, microphone, touch screen, and one or more output devices, e.g., a printing device, display screen, or speaker. In addition, computer system may contain one or more interfaces that connect computer system to a communication network in addition or as an alternative to the interconnection mechanism.

The storage system typically includes a computer readable and writeable nonvolatile recording medium in which signals are stored that define a program to be executed by the processor or information stored on or in the medium to be processed by the program. The medium may, for example, be a disk or flash memory. Typically, in operation, the processor causes data to be read from the nonvolatile recording medium into another memory that allows for faster access to the information by the processor than does the medium. This memory is typically a volatile, random access memory such as a dynamic random access memory (DRAM) or static memory (SRAM). It may be located in storage system or in memory system. The processor generally manipulates the data within the integrated circuit memory and then copies the data to the medium after processing is completed. A variety of mechanisms are known for managing data movement between the medium and the integrated circuit memory element and the invention is not limited thereto. The invention is not limited to a particular memory system or storage system.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

Although computer system is disclosed by way of example as one type of computer system upon which various aspects of the invention may be practiced, it should be appreciated that aspects of the invention are not limited to being implemented on the computer system as described herein. It should be appreciated that various aspects of the invention may be practiced on one or more computers having a different architecture or components than that disclosed herein.

Computer system may be a general-purpose computer system that is programmable using a high-level computer programming language. Computer system may be also implemented using specially programmed, special purpose hardware. In computer system, the processor is typically a commercially available processor such as the well-known Pentium class processor available from the Intel Corporation. Many other processors are available. Such a processor usually executes an operating system which may be, for example, the Windows 95, Windows 98, Windows NT, Windows 2000 (Windows ME) or Windows XP operating systems available from the Microsoft Corporation, MAC OS System X available from Apple Computer, the Solaris Operating System available from Sun Microsystems, or UNIX available from various sources. Many other operating systems may be used.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects of the invention may be performed on a client-server system that includes components distributed among one or more server systems that perform various functions according to various embodiments of the invention. These components may be executable, intermediate (e.g., IL), or interpreted (e.g., Java) code which communicate over a communication network (e.g., the Internet) using a communication protocol (e.g., TCP/IP).

It should be appreciated that the invention is not limited to executing on any particular system or group of systems. Also, it should be appreciated that the invention is not limited to any particular distributed architecture, network, or communication protocol.

Various embodiments of this invention may be programmed using an object-oriented programming language, such as SmallTalk, Java, C++, Ada, or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML, or other format that, when viewed in a window of a browser program, render aspects of a graphical-user interface (GUI) or perform other functions). Various aspects of the invention may be implemented as programmed or non-programmed elements, or any combination thereof.

One exemplary format for a lottery game and associated method of operation according to this invention is called Photo Lotto 100 herein. Aspects of such an exemplary game are disclosed in US Published Patent Application Nos. 2013/0260857 and 2013/0012288, each of which is hereby incorporated by reference in its entirety.

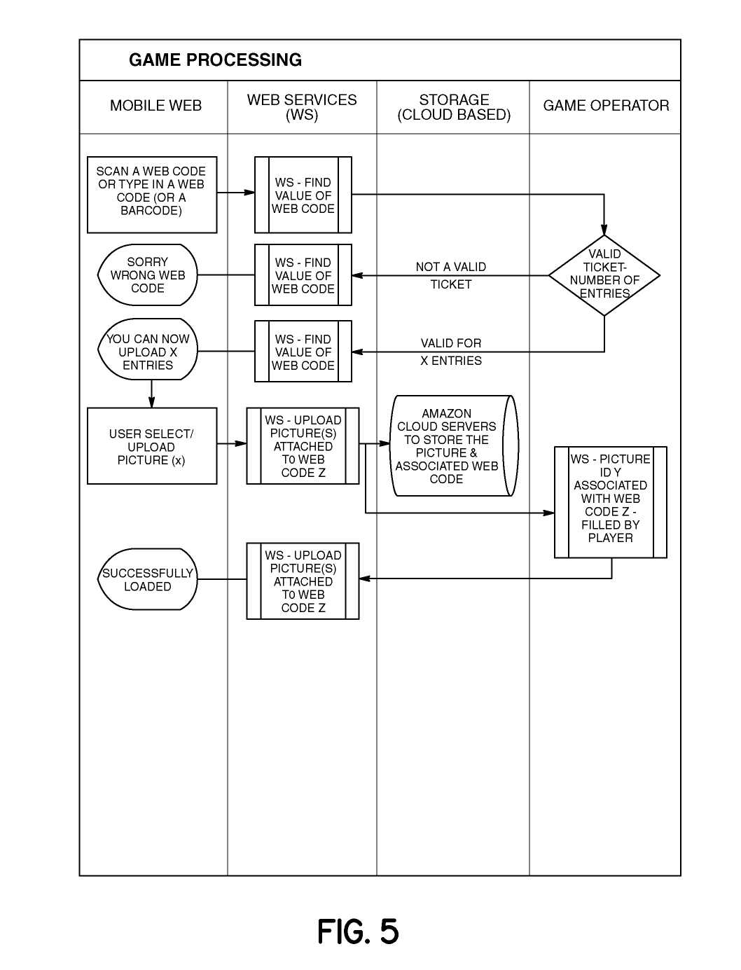

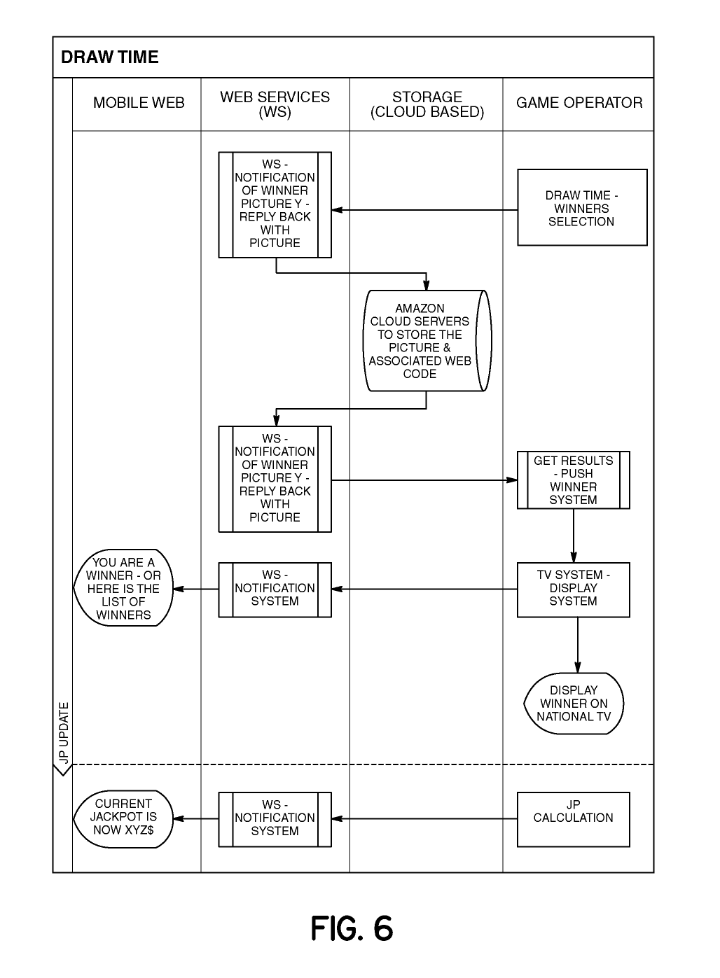

The Photo Lotto game 100 format (see FIGS. 5-6) offers three ways to win according to one embodiment:
A. A match game where a player can win immediately at the retail site and an amount up to a rolling matching prize that starts at $50,000.
B. A weekly drawing where a player can enter a picture for a chance to win up to $50,000.
C. A weekly TV show where a player can compete for the top prize of $4000,000.

A player 22 may purchase an entry at a regular lottery retailer for $5. The player 22 may play and win the match game immediately and at the same time enter his/her picture for a chance to be on the TV show and the weekly drawing via his/her smart phone 28, computer 30, electronic device or otherwise online.

Each such ticket 20 may be printed through a regular lottery terminal 24 or self-service terminal and it offers two games: the match game and the weekly photo drawing.

The match game offers an easy TIC-TAC-TOE play style in one embodiment according to this invention. The player 20 wins by matching three numbers to three “Photo numbers” in a row or by matching all “Photo numbers”. All numbers are randomly generated and the ticket 20 cannot be canceled. The player 20 wins immediately and there is no need to wait for a drawing.

The match game may have four winning tiers and all prizes (but the rolling matching prize) can be redeemed at the retail site or point of purchase. The rolling matching prize starts at $50,000 and increases real-time with sales in one embodiment of this invention. The rolling prize can be updated at a regular interval, such as every 3-5 minutes, and can be advertised both on the printed tickets and the lottery monitors inside the lottery retailer site (on the PADs—Player Advertising Displays). On average, it is expected that there may be as many as one hundred top winners per week across a multi jurisdictional format (i.e., nationwide for the whole US) and each winner may realize on average $100,000.

In total, every week it would be expected that 1,114,100 players would win a total of $24,732,687 in prizes. In addition, one could expect the rolling prize to increase by about $990 every two minutes based on the above described example of one embodiment of this invention.

Each jurisdiction 14 may have the opportunity to individualize its payout structure by adding prize tiers and changing payout percentages as long as the jurisdiction allocates the same amount as other jurisdictions to the top rolling jackpot 34.

Referring to FIG. 5, the player 22 may enter his/her picture for the weekly drawing either via his/her Smartphone, online or another means according to this invention. The picture can be any picture that the player has taken with his/her phone or his/her account on Instagram or Facebook or the like. The picture doesn't need to be a picture of the player himself/herself, but it could also be a picture of their pets, their new manicure or their favorite motorcycle, etc. These pictures will not be sold or used in any other way than for purposes of the Photo Lotto game 100 according to aspects of this invention.

The player may download the Photo Lotto app on their phone and go through an easy basic registration process so as to allow the lottery jurisdiction(s) 14 to be able to contact them as needed in case of being a winner or other. The player can then upload his/her photo by either scanning the quick response (QR) code with the Photo Lotto app or by manually entering the code below the QR code. Each Photo Lotto ticket offers one photo entry to the weekly drawing in one embodiment of this invention.

The weekly Photo Lotto drawing may be incorporated into the weekly television (TV) show. Every week, 2-3 hours before the TV show starts, two hundred pictures out of the pool of all submitted pictures of that week may be randomly selected to be on the TV show. These are the two hundred pictures that may be pre-checked for inappropriate content for national TV. Entries will not be deleted, but inappropriate pictures may be changed to another image or the like.

At the beginning of the TV show, all two hundred pictures will appear in a big carousel. Out of those two hundred pictures, twenty-five are randomly selected to appear in a five by five (5×5) grid. All these twenty-five pictures are winners of the weekly drawing. As the game continues, pictures are randomly eliminated and at the end only one picture remains. That last picture wins $50,000 and each of the other remaining twenty four wins $5,000 (or $120,000 in total).

In addition, out of the initial two hundred pictures, the owners of three pictures may be randomly invited to participate on next week's TV show game.

Every week three contestants are invited to participate in the Photo Lotto Show (as described above). All expenses for travel, accommodation, etc. may be covered from the production company.

As described before, twenty five pictures are randomly selected for the first round of the game. All twenty five pictures may be displayed on a big screen in front of the contestants in a grid of five by five (5×5).

Each contestant may start the game with 1,000 Photo Money in their accounts. Each contestant is given an identifying color (red, blue and green). Each selected picture has now the color of its selector and the amount bet (please see below).

One contestant after the other (based on the initial random order) is asked to select one picture out of the twenty five until every contestant has selected five pictures each (fifteen pictures total). Each contestant is then asked to bet on the five selected pictures with portions of their photo money. Each contestant may bet on each potential photo and 100% of their money must be bet across the five potential outcomes. For example, a first player may decide to bet $200 in each of the five pictures while a second player may prefer to bet $500 on one picture and then $100 on each of the remaining four pictures.

When the betting is over, twenty pictures are randomly selected out of the twenty five. Each contestant gets to keep the money they bet on the selected pictures and loses the rest.

Twenty pictures are now left out of twenty five. Each contestant in the second round is now asked to bet their remaining money on five pictures. These pictures can be different to the ones that they chose during the first round.

Just like before, ten pictures are now randomly selected out of the remaining twenty. The contestants get to keep the money they bet on the selected pictures.

The third round is considered an elimination round in which ten pictures are now left out of twenty five. Each contestant is now asked to bet their remaining money on three pictures. These pictures can be different to the ones that they chose during the previous rounds.

Just like before, three pictures are now randomly selected out of the remaining ten. The contestants get to keep the money they bet on the selected pictures. If all three contestants survive this round, the one with the less money in their account is awarded third prize and the second with the second prize.

In the fourth round, only one player is still playing. Three pictures are now left out of twenty five. The contestant is now playing either for the first prize of $100,000 or the big $1 million prize. In order for the player to win that big prize, they need to guess which picture it is going to be randomly selected. At the same time, the last picture to be selected is the big winner of the Photo Lotto weekly drawing.

Having now described some illustrative embodiments of the invention, it should be apparent to those skilled in the art that the foregoing is merely illustrative and not limiting, having been presented by way of example only. Numerous modifications and other illustrative embodiments are within the capabilities of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments.

From the above disclosure of the general principles of this invention and the preceding detailed description of at least one embodiment, those skilled in the art will readily comprehend the various modifications to which this invention is susceptible. Therefore, we desire to be limited only by the scope of the following claims and equivalents thereof.

We claim:

1. A method of conducting a multi-jurisdictional lottery game comprising the steps of:
maintaining a jackpot for the multi-jurisdictional lottery game;
establishing a minimum jackpot amount for the multi-jurisdictional game;
coordinating with a plurality of jurisdictions regarding a plurality of individual jurisdictional lottery games each being conducted within one of the plurality of jurisdictions in which a plurality of lottery players each participate in one of the individual jurisdictional lottery games in one of the jurisdictions by purchasing a lottery chance at a lottery game price;
wherein the individual jurisdictional lottery game of a first jurisdiction differs from the individual jurisdictional lottery game of a second jurisdiction within the multi-jurisdictional lottery game by at least one of the following characteristics: game theme, odds, payout, random generation of winning symbols, dividends and tiers;
receiving from each of the plurality of jurisdictions a portion of the lottery game price for each lottery chance purchased by each of the plurality of lottery players;
adding the portion of the lottery game price received from each of the plurality of jurisdictions to the jackpot for the multi-jurisdictional lottery game;
communicating to each of the plurality of jurisdictions an updated jackpot amount after the adding step;
receiving a notification from at least one of the jurisdictions that a potential winning jackpot player has won the multi-jurisdictional lottery game;
verifying that the potential winning jackpot player has won the multi-jurisdictional lottery game;
notifying each of the plurality of jurisdictions that the multi-jurisdictional lottery game has been won; and
re-establishing the jackpot at the minimum jackpot amount.

2. The method of claim 1 further comprising:
after the re-establishing step, repeating the coordinating, receiving, adding, communicating, receiving, verifying and notifying steps.

3. The method of claim 1 wherein the steps are performed in the order recited in claim 1.

4. The method of claim 1 wherein the communicating step is performed repeatedly at a regular and predetermined time interval.

5. The method of claim 1 wherein the receiving the notification step further comprises:
receiving a first notification from a first one of the plurality of jurisdictions that a first potential winning jackpot player has won the multi jurisdictional lottery game;
receiving a second notification from a second one of the plurality of jurisdictions that a second potential winning jackpot player has won the multi-jurisdictional lottery game; and
determining whether the first or the second potential winning jackpot player has won the multi jurisdictional lottery game.

6. The method of claim 1 further comprising:
after the communicating step, communicating to at least selected ones of the plurality of lottery players the updated jackpot amount.

7. The method of claim 1 wherein each of the individual jurisdictional lottery games is a fast play lottery game.

8. A method of conducting a multi jurisdictional lottery game comprising the following steps in order:
maintaining a jackpot for the multi jurisdictional lottery game;
establishing a minimum jackpot amount for the multi jurisdictional game;
coordinating with a plurality of jurisdictions regarding a plurality of individual jurisdictional lottery games each being conducted within one of the plurality of jurisdictions in which a plurality of lottery players each participate in one of the individual jurisdictional lottery games in one of the jurisdictions by purchasing a lottery chance at a lottery game price;
wherein the individual jurisdictional lottery game of a first jurisdiction differs from the individual jurisdictional lottery game of a second jurisdiction within the multi-jurisdictional lottery game by at least one of the following characteristics: game theme, odds, payout, random generation of winning symbols, dividends and tiers;
receiving from each of the plurality of jurisdictions a portion of the lottery game price for each lottery chance purchased by each of the plurality of lottery players;
adding the portion of the lottery game price received from each of the plurality of jurisdictions to the jackpot for the multi-jurisdictional lottery game;
communicating at a regular interval to each of the plurality of jurisdictions an updated jackpot amount after the adding step;
receiving a notification from at least one of the jurisdictions that a potential winning jackpot player has won the multi jurisdictional lottery game;
verifying that the potential winning jackpot player has won the multi-jurisdictional lottery game;
notifying each of the plurality of jurisdictions that the multi jurisdictional lottery game has been won;
re-establishing the jackpot at the minimum jackpot amount;
repeating the coordinating, receiving, adding, communicating, receiving, verifying and notifying steps.

9. The method of claim 8 wherein the receiving the notification step further comprises:
receiving a first notification from a first one of the plurality of jurisdictions that a first potential winning jackpot player has won the multi jurisdictional lottery game;
receiving a second notification from a second one of the plurality of jurisdictions that a second potential winning jackpot player has won the multi-jurisdictional lottery game; and
determining whether the first or the second potential winning jackpot player has won the multi jurisdictional lottery game.

10. A tangible, non-transitory computer readable medium having computer readable medium storing signals thereon that define code instructions that, as a result of being executed by a computer, instruct the computer to perform a method of conducting a multi jurisdictional lottery game comprising the steps of:
maintaining a jackpot for the multi-jurisdictional lottery game;
establishing a minimum jackpot amount for the multi-jurisdictional game;
coordinating with a plurality of jurisdictions regarding a plurality of individual jurisdictional lottery games each being conducted within one of the plurality of jurisdictions in which a plurality of lottery players each participate in one of the individual jurisdictional lottery games in one of the jurisdictions by purchasing a lottery chance at a lottery game price;
wherein the individual jurisdictional lottery game of a first jurisdiction differs from the individual jurisdictional lottery game of a second jurisdiction within the multi-jurisdictional lottery game by at least one of the following characteristics: game theme, odds, payout, random generation of winning symbols, dividends and tiers;
receiving from each of the plurality of jurisdictions a portion of the lottery game price for each lottery chance purchased by each of the plurality of lottery players;
adding the portion of the lottery game price received from each of the plurality of jurisdictions to the jackpot for the multi-jurisdictional lottery game;
communicating to each of the plurality of jurisdictions an updated jackpot amount after the adding step;
receiving a notification from at least one of the jurisdictions that a potential winning jackpot player has won the multi-jurisdictional lottery game;
verifying that the potential winning jackpot player has won the multi-jurisdictional lottery game;
notifying each of the plurality of jurisdictions that the multi-jurisdictional lottery game has been won; and
re-establishing the jackpot at the minimum jackpot amount.

11. The tangible, non-transitory computer readable medium of claim 10 further comprising:
after the re-establishing step, repeating the coordinating, receiving, adding, communicating, receiving, verifying and notifying steps.

12. The tangible, non-transitory computer readable medium of claim 10 wherein the steps are performed in the order recited in claim 11.

13. The tangible, non-transitory computer readable medium of claim 10 wherein the communicating step is performed repeatedly at a regular and predetermined time interval.

14. The tangible, non-transitory computer readable medium of claim 10 wherein the receiving the notification step further comprises:
receiving a first notification from a first one of the plurality of jurisdictions that a first potential winning jackpot player has won the multi jurisdictional lottery game;
receiving a second notification from a second one of the plurality of jurisdictions that a second potential winning jackpot player has won the multi-jurisdictional lottery game; and
determining whether the first or the second potential winning jackpot player has won the multi jurisdictional lottery game.

15. The tangible, non-transitory computer readable medium of claim 10 further comprising:
after the communicating step, communicating to at least selected ones of the plurality of lottery players the updated jackpot amount.

16. The tangible, non-transitory computer readable medium of claim 10 wherein each of the individual jurisdictional lottery games is a fast play lottery game.

17. A program product embodied in one or more tangible computer readable media, the program product including code executable by a computer machine and at least one gaming server for:
maintaining a jackpot for the multi-jurisdictional lottery game;
establishing a minimum jackpot amount for the multi-jurisdictional game;
coordinating with a plurality of jurisdictions regarding a plurality of individual jurisdictional lottery games each being conducted within one of the plurality of jurisdictions in which a plurality of lottery players each participate in one of the individual jurisdictional lottery games in one of the jurisdictions by purchasing a lottery chance at a lottery game price;
wherein the individual jurisdictional lottery game of a first jurisdiction differs from the individual jurisdictional lottery game of a second jurisdiction within the multi-jurisdictional lottery game by at least one of the following characteristics: game theme, odds, payout, random generation of winning symbols, dividends and tiers;
receiving from each of the plurality of jurisdictions a portion of the lottery game price for each lottery chance purchased by each of the plurality of lottery players;
adding the portion of the lottery game price received from each of the plurality of jurisdictions to the jackpot for the multi-jurisdictional lottery game;
communicating to each of the plurality of jurisdictions an updated jackpot amount after the adding step;
receiving a notification from at least one of the jurisdictions that a potential winning jackpot player has won the multi-jurisdictional lottery game;
verifying that the potential winning jackpot player has won the multi-jurisdictional lottery game;
notifying each of the plurality of jurisdictions that the multi-jurisdictional lottery game has been won; and
re-establishing the jackpot at the minimum jackpot amount.
